(19) United States
(12) Patent Application Publication
(10) Pub. No.: US 2008/0126813 A1
(43) Pub. Date: May 29, 2008

(54) Storage control device and method of controlling encryption function of storage control device

(75) Inventor: Norihiko Kawakami, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/599,296

(22) Filed: Nov. 15, 2006

(30) Foreign Application Priority Data
Sep. 21, 2006 (JP) 2006-255290

(51) Int. Cl. G06F 12/14

(52) U.S. Cl. 713/193

(57) ABSTRACT

The storage control device of the present invention suppresses a drop in the performance of a host and storage control device by preventing the execution of encryption processing in the host and storage control device. The user presets an attribute that relates to the encryption of each storage device by considering the type of data transmitted from a higher order device (encryption data or plain data, for example) and the importance of the data and so forth. Such user operating policies are registered in a configuration management section via a setting section. When the data received from the higher-level device are encryption data, the storage control device stores the data in the storage device as is without performing encryption processing. When the received data are plain data, the storage control device converts the plain data into encryption data by performing encryption processing and stores the encryption data in the storage device.

### CROSS-REFERENCE TO RELATED APPLICATIONS

This application relates to and claims priority from Japanese Patent Application No. 2006-255290 filed on Sep. 21, 2006, the entire disclosure of which is incorporated herein by reference.

### BACKGROUND OF THE INVENTION

1. Field of the Invention

The present invention relates to a method of controlling a storage control device and an encryption function of the storage control device.

2. Description of the Related Art

In an organization such as an enterprise, a storage control device that is constituted separately from a host computer (‘host’ hereinbelow) is used to manage large amounts of data. Such a storage control device contains a multiplicity of storage devices such as hard disk drives, for example, and provides the host with a large-capacity storage region.

The storage control device stores, for example, a variety of important information such as personal information such as a person's address and full name, and information relating to the signal state. Hence, a technology for preventing illegal access and so forth by secretly managing important information is required.

Encryption technology is sometimes used in order to protect data. Data in the host is encrypted and illegal use of the encrypted data by a third party can be prevented by transmitting this encrypted data to the storage control device and storing same therein.

However, when data are encrypted in the host, the data processing load of the host increases and this also has an adverse effect on the performance of the application program running on the host. Hence, a technology that makes it possible to encrypt data in the storage control device has been proposed (Japanese Patent Application Laid Open No. 2005-322201).

In the prior art that appears in Japanese Patent Application Laid Open No. 2005-322201, an encryption processing section is provided between a host interface connected to the host and a transfer control section in a channel interface that controls communication with the host. The data received from the host are encrypted by the encryption processing section, whereupon the data are written to a hard disk drive. In the prior art, the processing load of the host can be lightened by performing data encryption in the storage control device. However, in the prior art, all the data received from the host is uniformly encrypted in the storage control device. Therefore, even when data that has already been encrypted in the host is received, encryption is performed once again in the storage control device for the encrypted data. That is, because data processing for encryption is executed by the host and storage control device respectively, when the storage system as a whole is considered, futile repeated encryption is performed.

The re-encryption in the storage control device of data that has already been encrypted in the host induces a drop in the performance of the storage control device. By performing data processing for encryption, the data processing load of the storage control device increases and, therefore, the response performance and so forth drops. In addition, when the host issues a request to the storage control device that data that has been encrypted in the storage control device be read, the storage control device must transmit the encrypted data to the host after decrypting the data. Hence, in the prior art, there is the possibility of a drop in the performance of the storage control device in both cases where a write command is issued by the host and also cases where a read command is issued.

There is the possibility that the OS (Operating System) and the application programs and so forth installed on the host are a mix of programs that have an encryption function and programs that do not have an encryption function. One OS or application program is able to encrypt and transmit data to the storage control device while the other OS or application program does not comprise a function for encrypting data.

Hence, in the case of a storage control device that is shared by a plurality of hosts, as per the prior art, the way of encrypting data uniformly in the storage control device may also be said to be fail safe irrespective of the type of host and OS and so forth. However, when the host has a function for encrypting data, as mentioned earlier, because repeated encryption is executed in the storage control device, the data processing load of the host and storage control device increase in vain, there is a possibility of inducing a drop in the performance of the host and storage control device, and user convenience drops.

### SUMMARY OF THE INVENTION

Therefore, an object of the present invention is to provide a storage control device and a method of controlling an encryption function of the storage control device that prevents futile encryption from being performed by individually encrypting data received from a higher order device if required so that a drop in performance can be suppressed. A further object of the present invention is to provide a storage control device and method of controlling an encryption function of the storage control device that is able to satisfy the requirements of user convenience and stability as a result of the user presetting the data which is the encryption target. Further objects of the present invention will become apparent from the following description of the embodiments.

In order to achieve the above problem, the storage control device according to a first aspect of the present invention is a storage control device that reads and writes data in accordance with a request from a higher-level device, comprising a storage device for storing data received from the higher-level device; and a controller for controlling the input and output of data to and from the storage device, wherein the controller comprises: a configuration management section for managing configuration relating to the encryption of the data received from the higher-level device; an encryption control section for determining, based on the configuration managed by the configuration management section, whether to encrypt the data received from the higher-level device and store these data in the storage device; and an encryption processing section that encrypts the data when the encryption control section has determined that the data are to be encrypted.

In the embodiment of the present invention, the storage device is constituted as a logical storage device that is provided in a physical storage region of one or a plurality of physical storage drives.

In the embodiment of the present invention, the higher-level device comprises an encryption function that encrypts data in the higher-level device before transmitting these data to the storage control device.

In the embodiment of the present invention, a plurality of the higher-level device are provided, the higher-level devices consisting of a mixture of higher-level devices that comprise an encryption function that encrypts data in the higher-level device before transmitting these data to the storage control device and higher-level devices that do not comprise the encryption function.

In the embodiment of the present invention, the encryption control section has a discrimination function that discriminates whether the data received from the higher-level device have been encrypted.

In the embodiment of the present invention, the encryption control section comprises a discrimination function that discriminates whether the data has been encrypted by analyzing the data received from the higher-level device and, when the data received from the higher-level device have already been encrypted, the data are stored in the storage device as is and, when the data received from the higher-level device have not been encrypted, the data are stored in the storage device after being encrypted by the encryption processing section.

In the embodiment of the present invention, the configuration managed by the configuration management section includes encryption target information.

In the embodiment of the present invention, the encryption target is the higher-level device unit.

In the embodiment of the present invention, the encryption target is an application program unit that is provided in the higher-level device.

In the embodiment of the present invention, the encryption target is an operating system unit that is provided in the higher-level device.

In the embodiment of the present invention, the configuration managed by the configuration management section includes information on the encryption target that executes the encryption by the encryption processing section and designation information that designates whether to perform encryption by means of the encryption processing section with respect to the encryption target, and the information on the encryption target and the designation information can be set by the user.

In the embodiment of the present invention, the setting section for changing the content of the configuration managed by the configuration management section is connected to the controller.

In the embodiment of the present invention, the control section provided in the storage device comprises an encryption circuit for encrypting data that are input, and the encryption processing section encrypts the data received from the higher-level device by using the encryption circuit in the storage device.

In the embodiment of the present invention, a mixture of the storage devices that includes storage devices that comprise an encryption circuit for encrypting data that are input and storage devices that do not comprise the encryption circuit are provided; the controller selects another storage device that comprises the encryption circuit as the write destination when the storage device designated as the write destination of the data received from the higher-level device does not comprise the encryption circuit; and the encryption processing section encrypts the data received from the higher-level device by using the encryption circuit of the other storage device.

In the embodiment of the present invention, a mixture of storage devices that includes storage devices that comprise an encryption circuit for encrypting data that are input and storage devices that do not comprise the encryption circuit are provided; the controller encrypts the data received from the higher-level device by means of the encryption processing section and stores the data in the designated storage device when the storage device designated as the write destination of the data received from the higher-level device does not comprise the encryption circuit; and the encryption processing section encrypts the data received from the higher-level device by using the encryption circuit of the designated storage device when the designated storage device comprises the encryption circuit.

In the embodiment of the present invention, the controller comprises a file management section for performing file management, the file management section comprises a file encryption control section that encrypts the data received from the higher-level device in file units; and the file encryption control section encrypts the data received from the higher-level device in the file units and stores these data in the storage device on the basis of the configuration managed by the configuration management section.

In the embodiment of the present invention, the controller is also connected to another storage control device, and in cases where data stored in the storage device are transferred to the other storage control device, the data are transferred to the other storage control device as is without being decrypted when the data stored in the storage device have been encrypted, and the data are transferred to the other storage control device after being encrypted when the data stored in the storage device have not been encrypted.

The storage control device connected to a higher-level device and management terminal according to a further aspect of the present invention comprises a storage device for storing data received from the higher-level device; and a controller for controlling the input and output of data to and from the storage device, wherein the controller comprises: a upper communication section for controlling communication with the higher-level device; a lower communication section for controlling communication with the storage device; a management table for managing configuration relating to the encryption of data preset via the management terminal; an encryption control section for determining whether to encrypt data received via the upper communication section from the higher-level device and for determining whether to decrypt data requested by the higher-level device on the basis of the configuration managed by the management table; an encryption processing section that encrypts the data when the encryption control section has determined that the data are to be encrypted; and a decrypting processing section that decrypts the data when the encryption control section has determined that the data are to be decrypt.

A method of controlling an encryption function in a storage control device that reads and writes data in accordance with requests from a higher-level device according to yet another aspect of the present invention comprises the steps of: pre-registering an encryption target that performs data encryption in a management table; receiving data from the higher-level device; judging whether the data received from the higher-level device are data relating to the encryption target by using the management table; determining that the data are to be encrypted when it is judged that the data received from the higher-level device are data that are related to the encryption target; encrypting the data whose encryption has been determined; storing the encrypted data in a storage device; and storing the data in the storage device as is when it is judged that the data received from the higher-level device are data that are unrelated to the encryption target.

All or part of the constituent elements of the present invention can sometimes be constituted as a computer program. In addition to the possibility of transferring the computer program fixed to a recording medium, the computer program can also be transmitted via a communication network such as the Internet.

### BRIEF DESCRIPTION OF THE DRAWINGS

FIG. 1 is an explanatory diagram of the concept of the embodiment of the present invention;

FIG. 2 is an explanatory diagram showing the overall constitution of the storage system comprising a storage control device according to a first embodiment;

FIG. 3 is an explanatory diagram showing an example of a screen for making settings with respect to the encryption of data;

FIG. 4 is an explanatory diagram of an encryption judgment table;

FIG. 5 is an explanatory diagram of an LU management table;

FIG. 6 is an explanatory diagram of an encrypted data address management table;

FIG. 7 is a flowchart showing a write-command processing method;

FIG. 8 is a flowchart showing a read-command processing method;

FIG. 9 is a flowchart showing encryption judgment processing;

FIG. 10 is a flowchart showing another example of encryption judgment processing;

FIG. 11 is a flowchart showing encryption processing;

FIG. 12 is a flowchart showing decrypting judgment processing;

FIG. 13 is a flowchart showing decrypting processing;

FIG. 14 is a flowchart showing processing for making encryption-related settings;

FIG. 15 is an explanatory diagram showing the overall constitution of a storage system that comprises a storage control device according to a second embodiment;

FIG. 16 is an explanatory diagram that schematically shows a method of controlling NAS encryption processing;

FIG. 17 is a flowchart showing a method of controlling NAS encryption;

FIG. 18 is an explanatory diagram showing the overall constitution of a storage system that comprises a storage control device according to a third embodiment;

FIG. 19 is an explanatory diagram that shows the constitution of the controller and storage section partially removed;

FIG. 20 is a flowchart of a case where data undergoes encryption processing by using the encryption function installed in the disk drive;

FIG. 21 is an explanatory diagram that shows the overall constitution of a storage system that comprises a storage control device according to a fourth embodiment; and

FIG. 22 is a flowchart that shows a method of controlling encryption processing when data are transferred between a plurality of storage control devices.

### DESCRIPTION OF THE SPECIFIC EMBODIMENTS

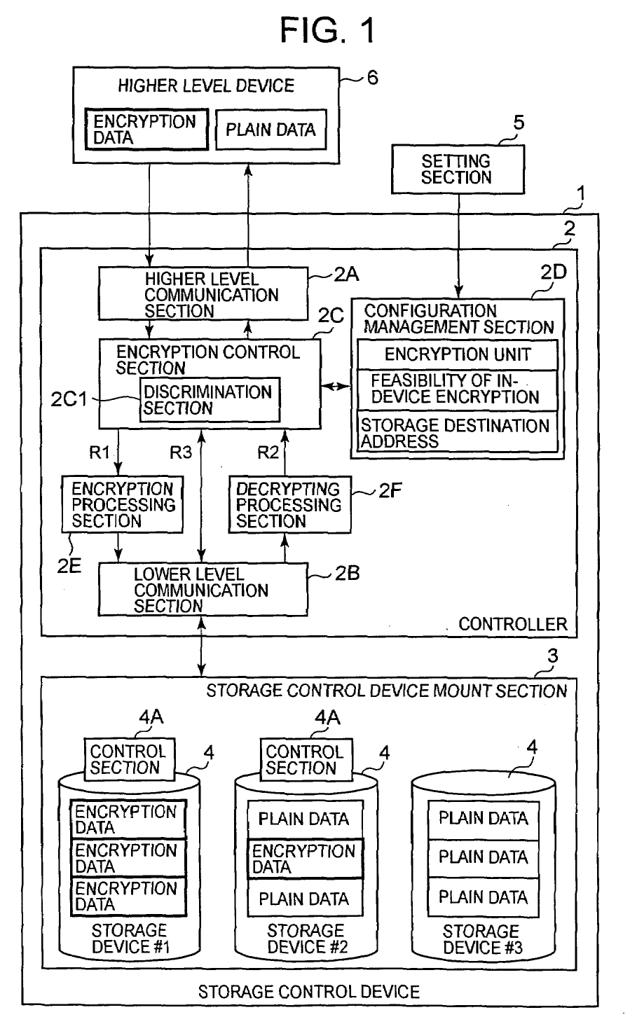

Embodiments of the present invention will be described hereinbelow on the basis of the drawings. FIG. 1 is an explanatory diagram that shows the overall concept of this embodiment. The storage system of this embodiment comprises, as described subsequently, for example, at least one storage control device 1, at least one higher order device 6, and at least one setting section 5.

The higher order device 6 will now be described. Although only one higher order device 6 is shown in FIG. 1 for the sake of expedience in the description, a plurality of higher order device 6 can in fact be connected to the storage control device 1. The higher order device 6 is constituted as a computer device such as a server computer and mainframe machine, for example. The higher order device 6 corresponds to the host 500 of the subsequently described embodiment. The higher order device 6 has a function for encrypting data. In the following description, encrypted data are sometimes known as encryption data and normal data that has not been encrypted is sometimes known as normal data or plain data. The data encryption function is sometimes provided in the OS, for example. Alternatively, there are also cases where an application program that runs on the higher order device 6 has the data encryption function. There are also cases where data encryption is performed by a special encryption device provided in the higher order device 6 or a special encryption device that is connected to the higher order device 6.

The higher order device 6 is connected to the storage control device 1 via a communication network such as a SAN (Storage Area Network) or Internet, for example. Further, in the case of a SAN, technology such as an FCP (Fibre Channel Protocol) or iSCSI (internet Small Computer System Interface), for example, can be used.

The constitution of the storage control device 1 will now be described. The storage control device 1 corresponds to a storage control device 100 of an embodiment that will be described subsequently. The storage control device 1 is constituted comprising a controller 2 and a storage device mount section 3, for example.

The controller 2 controls the overall operation of the storage control device 1. The controller 2 writes data received from the higher order device 6 to a storage device 4 in accordance with a write command that is received from the higher order device 6. Further, the controller 2 reads data requested from the higher order device 6 from the storage device 4 in accordance with a read command received from the higher order device 6 and transmits the data thus read to the higher order device 6. In the subsequent description, data whose reading 6 is requested from the higher order device is sometimes referred to as write data and data whose reading is requested from the higher order device 6 is sometimes referred to as read data. Further, as will be described subsequently, the controller 2 is also able to encrypt write data if required and write same to the storage device 4 and decrypt the encryption data read from the storage device 4 to convert same into plain data.

The controller 2 can be constituted comprising, for example, a upper communication section 2A, a lower communication section 2B, an encryption control section 2C, a configuration management section 2D, an encryption processing section 2E, and a decrypting processing section 2F.

The upper communication section 2A controls communications with the higher order device 6. The lower communication section 2B controls communications with each storage device 4 of the storage device mount section 3. The upper communication section 2A and lower communication section 2B are constituted as a computer device comprising a unique processor and local memory.

The encryption control section 2C controls the encryption and decrypting that are carried out in the storage control device 100. The encryption control section 2C determines whether or not to encrypt write data received from the higher order device 6 and whether or not to decrypt read data read from the storage device 4 on the basis of configuration that is stored in the configuration management section 2D.

The configuration management section 2D stores and manages encryption-related configuration. Configuration can be registered by the setting section 5 that is connected via a LAN (Local Area Network) or the like to the storage control device 1. The user is able to predetermine which data to encrypt and so forth on the basis of the operations policy or the like of the storage system. The user is able to pre-store configuration reflecting the operations policy in the configuration management section 2D by using the setting section 5. Configuration can include, for example, the unit of the target to be encrypted, a designation of whether to perform encryption in the storage control device 1, and a storage destination address or the like when encrypting data.

The encryption processing section 2E encrypts data judged that is judged as requiring encryption by the encryption control section 2C. The decrypting processing section 2F decrypts data that is judged as requiring decrypting by the encryption control section 2C.

The storage device mount section 3 comprises a plurality of storage devices 4. The storage device mount section 3 is sometimes provided in the same enclosure as the controller 2 or sometimes provided in a separate enclosure from the controller 2.

The storage device 4 is constituted as a rewritable nonvolatile storage device, for example. A variety of storage devices capable of reading and writing data such as a hard disk device, semiconductor memory device, optical disk device, magneto-optical disk device, magnetic tape device, and a flexible disk device, for example, can be used as the storage device 4.

When a hard disk device is used as the storage device 4, various hard disk devices such as an FC (Fibre Channel) disk, SCSI (Small Computer System Interface) disk, SATA disk, ATA (AT Attachment) disk, SAS (Serial Attached SCSI) disk, for example, can be used.

When a semiconductor memory device is used as the storage device 4, a variety of memory devices such as a flash memory, FeRAM (Ferroelectric Random Access Memory), MRAM (Magnetoresistive Random Access Memory), Ovonic Unified Memory, and RRAM (Resistance RAM), for example, can be utilized.

The storage device 4 comprises a storage device 4A that is able to perform encryption and decrypting. In FIG. 1, the storage device 4A is shown as a circuit that is capable of executing encryption processing and decrypting processing. That is, storage devices 4 (#1, #2) that comprise the storage device 4A that is capable of encryption processing and storage device 4 (#3) that does not comprise the storage device 4A are provided in mixed fashion in the storage device mount section 3 shown in FIG. 1. The storage device 4 (#3) is provided with a normal control circuit that does not have an encryption processing and decrypting processing function (not illustrated).

Plain data or encryption data are stored in the storage devices 4. One storage device 4 (#1) that is shown on the left side is used as an encryption storage region for storing encryption data and stores only encryption data. Another storage device 4 (#3) that is shown on the right side is used as a non-encryption storage region for storing plain data (or may be expressed as a ‘normal storage region’) and stores only plain data. Another one storage device 4 (#2) that is shown in the center is used as a mixed storage region that stores both encryption data and also plain data.

Further, although three storage devices 4 are shown in FIG. 1, each storage device 4 is actually constituted by one or a plurality of physical storage devices. As will be described in subsequent embodiments, the storage region that the plurality of physical storage devices comprise is virtualized and a logical storage region (logical volume) can be provided in the virtualized physical region (RAID group). The storage device 4 in FIG. 1 represents a logical volume.

A method for setting configuration will be described next. As a first example, when all the data transmitted from the higher order device 6 are encrypted in the higher order device 6, there is no need to perform repeated encryption in the storage control device 1. Further encrypting data that has already been encrypted possibly brings about a drop in the performance of the storage control device 1.

In this case, the user sets a storage device 4 that is not being used by the higher order device 6 as a non-encryption storage region for the higher order device 6 that comprises an encryption function. As a result, encryption data received from the higher order device 6 are stored as is in the storage device 4 set in the non-encryption region. As indicated by numeral R3 in FIG. 1, the encryption data received from the higher order device 6 is transferred as is to the storage device 4. When the higher order device 6 has requested data reading from the storage device 4 set in the non-encryption region, the storage control device 1 reads encryption data stored in the storage device 4 and transmits the encryption data to the higher order device 6. The decrypting of encryption data is performed within the higher order device 6.

In the case of the first example, the processing to encrypt the data is executed only by the higher order device 6. Therefore, because the encryption data are transmitted from the higher order device 6, the possibility of the encryption data being intercepted on the communication channel and illegally used can be markedly reduced and a drop in the performance of the storage control device 1 can be prevented.

As a second example, a case where encryption is not performed in the higher order device 6 and plain data are transmitted is investigated. When the user desires an increase in security, the storage device 4 that is being used by the higher order device 6 that transmits the plain data is set as the encryption storage region. Data that have been encrypted in the storage control device 1 are written to the storage device 4 set as the encryption storage region. That is, the storage control device 1 encrypts plain data received from the higher order device 6 in the storage control device 1 and stores this data in the storage device 4. As indicated by the numeral RI in FIG. 1, the data received from the higher order device 6 are transferred to the storage device 4 after being encrypted via the encryption processing section 2E. Further, the encryption processing section 2E is also able to control the encryption function that the storage device 4A of the storage device 4 comprises. As a result, the encryption processing section 2E is able to encrypt data by means of the storage device 4A and also able to lighten the burden on the controller 2. When the higher order device 6 requests the reading of data, the storage control device 1 reads encryption data from the storage device 4 and decrypts the encryption data thus read in the storage control device 1. The storage control device 1 then transmits the plain data to the higher order device 6.

In the case of the second example, the higher order device 6 need not perform encryption or decrypting of data and is therefore able to lighten the burden on the higher order device 6. Furthermore, the storage control device 1 encrypts and stores the plain data received from the higher order device 6 in the storage control device 1 and is therefore able to maintain security.

However, in the case of the second example, in order to prevent the plain data on the communication channel from being intercepted by a third party, a communication protocol with a security function such as “IP Security”, for example, is preferably used between the higher order device 6 and storage control device 1. If the higher order device 6 and storage control device 1 are directly connected and separated from a communication network that is shared by an unspecified multiplicity of users such as the Internet, plain data may be transmitted from the higher order device 6 to the storage control device 1 by using a communication protocol without a security function.

As a third example, a case where the user does not desire an improvement in the security of the second example is studied. That is, this is a case where the user judges that there is no need to encrypt plain data transmitted from the higher order device 6 and save this data in the storage control device 1. In this case, the storage device 4 that is used by the higher order device 6 is set as a non-encryption storage region. As a result, the plain data received from the higher order device 6 is written to the storage device 4 as is.

In the case of the third example, a drop in the performance of the higher order device 6 and storage control device 1 can be prevented. Data of low importance can be transmitted as plain data from the higher order device 6 to the storage control device 1 and, by saving the plain data as is in the storage control device 1, the burden on the storage system can be lightened.

As a fourth example, a case where the user desires a further improvement in security is studied in the first example. In this case, the user sets the storage device 4 used by the higher order device 6 that transmits the encryption data in the encryption storage region. As a result, the storage control device 1 further encrypts the encryption data received from the higher order device 6 in the storage control device 1 and stores the data in the storage device 4.

In the case of the fourth example, the encryption data transmitted from the higher order device 6 is encrypted and saved in the storage control device 1. Therefore, although the burden on the higher order device 6 and storage control device 1 increases, the security improves as a result of double encryption processing being performed. Furthermore, as mentioned earlier, when data that has been encrypted in the storage control device 1 is transmitted to the higher order device 6, as indicated by the numeral R2, encryption data are converted into plain data by the decrypting processing section 2F. When data are encrypted by the storage device 4A of the storage device 4, encryption data are decrypted by the storage device 4A. Further, even when data have been encrypted in the storage device 4, data can also be decrypted by the decrypting processing section 2F as a result of the decrypting processing section 2F acquiring the encryption key that was used for encryption.

Thus, the user is able to preset an attribute that relates to the encryption of each storage device 4 by considering the type of data transmitted from the higher order device 6 (encryption data or plain data), the importance and value of the data, and the strength of the security, and so forth, for example. Such user operating policies can be registered in the configuration management section 2D via a setting section 5 that can be constituted as a computer device.

A discrimination section 2C1 can also be set in the encryption control section 2C. The discrimination section 2C1 discriminates whether data received from the higher order device 6 has been encrypted. For example, the discrimination section 2C1 judges whether the data are encryption data or plain data by analyzing a portion (header or the like) of the data received from the higher order device 6.

When it is judged by the discrimination section 2C1 that the data are plain data, the storage control device 1 is able to encrypt the plain data and store same in the storage device 4. Even when the higher order device 6 comprises an encryption function, the encryption function is limited such that sometimes a portion of the files cannot be encrypted. For example, sometimes data relating to a specified file such as a system file cannot be encrypted.

When a portion of the data are not encrypted and transmitted from the higher order device 6 to the storage control device 1 as plain data, the storage control device 1 detects the plain data and is able to encrypt same. That is, in the first example, the storage device 4 used by the higher order device 6 is set in a non-encryption storage region with the prerequisite that encryption data are transmitted from the higher order device 6. However, as mentioned earlier, it is possible that a portion of the data will be transmitted to the storage control device 1 as is without encryption as plain data. In this case, the plain data that has not been encrypted is detected by the discrimination section 2C1. The storage control device 1 is able to encrypt the detected plain data in the storage control device 1 and write the encrypted data to a storage device 4 that has been set as the non-encryption storage region. Further, when the data are detected as plain data, the plain data can also be written to the storage device 4 as is without being encrypted.

According to this embodiment that is constituted in this way, suitable encryption can be performed depending on the type and so forth of the data and degradation of the performance of the storage control device 1 can be suppressed by preventing repeated encryption processing or the like from being executed. Further, because the decision of whether to perform encryption processing can be controlled on the basis of the operating policy of the user with respect to encryption, the convenience of the user also improves. The embodiment will be described in detail hereinbelow.

### First Embodiment

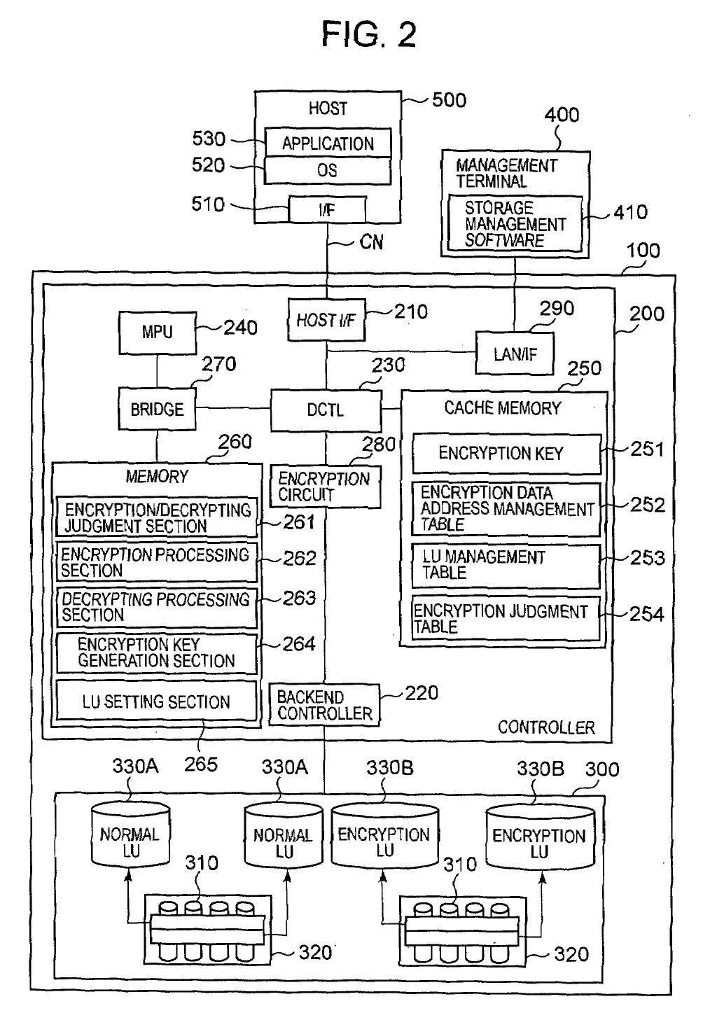

FIG. 2 is an explanatory diagram of the overall constitution of the storage system of this embodiment. The storage system is constituted comprising, for example, a storage control device 100 and a host 500 that is connected to the storage control device 100 via a communication network. To illustrate the relationship of correspondence with FIG. 1 beforehand, the storage control device 100 corresponds to the storage control device 1 in FIG. 1, the host 500 corresponds to the higher order device 6 in FIG. 1, and management terminal 400 corresponds to the setting section 5 in FIG. 1. Furthermore, the controller 200 corresponds to the controller 2 in FIG. 1 and the storage device mount section 300 corresponds to the storage device mount section 3 in FIG. 1. In addition, the encryption judgment table 254 corresponds to the configuration management section 2D in FIG. 1, the encryption/decrypting judgment section 261 corresponds to the encryption control section 2C in FIG. 1, the encryption processing section 262 corresponds to the encryption processing section 2E in FIG. 1, the decrypting processing section 263 corresponds to the decrypting processing section 2F in FIG. 1, the host interface 210 corresponds to the upper communication section 2A in FIG. 1, the backend controller 220 corresponds to the lower communication section 2B in FIG. 1, and the storage devices 330A and 330B correspond to the storage device 4 in FIG. 1.

The constitution of the host 500 will now be described. The host 500 comprises a communication interface (abbreviated to ‘I/F’ in FIG. 2) 510, an OS 520, and an application program 530, for example. The host 500 accesses the storage control device 100 via a communication network CN such as a SAN from the communication interface. When the application program 530 performs data processing such as a file operation, a command corresponding with the data processing is issued by the host 500. Commands can include a write command requesting the writing of data and a read command requesting the reading of data, and so forth.

There are cases where the OS 520 and application program 530 have an encryption function and cases where the OS 520 and application program 530 do not have an encryption function. An OS 520 or application program 530 that comprises an encryption function is able to transmit data to the storage control device 100 after encrypting the data. An OS 520 or application program 530 that does not comprise an encryption function transmits plain data (normal data) that has not been encrypted to the storage control device 100. Further, a special device for encrypting data can also be contained in the host 500 or connected to the host 500.

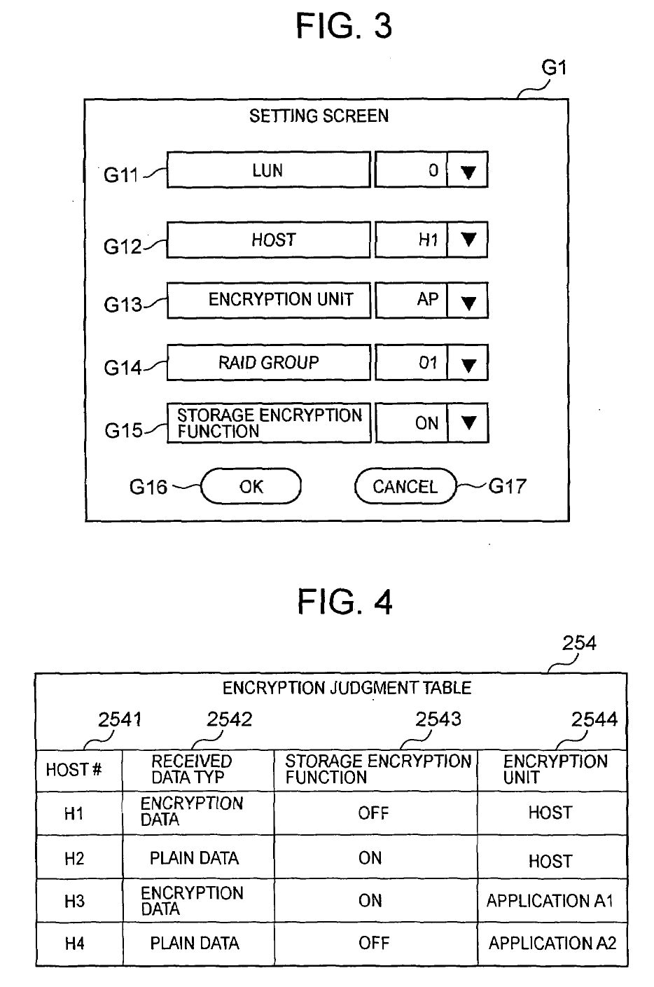

The constitution of the management terminal 400 will be described next. The management terminal 400 is constituted as a computer device and is connected to the storage control device 100 via a communication network such as a LAN. The management terminal 400 comprises storage management software 410. The storage management software 410 is a program that manages the constitution and setting state of the storage control device 100 to acquire and display a variety of information of the storage control device 100. The user is able to make a variety of settings relating to encryption by operating a management screen that is supplied by the storage management software 410. An example of the management screen will be described subsequently in conjunction with FIG. 3.

The constitution of the storage control device 100 will now be described. The storage control device 100 is broadly classified as the controller 200 and the storage device mount section 300, for example. The controller 200 controls the operation of the storage control device 100. The storage device mount section 300 comprises a plurality of storage devices 330A and 330B.

The constitution of the controller 200 will now be described. The controller 200 is constituted comprising a host interface 210, a backend controller 220, a data transfer control circuit (abbreviated as ‘DCTL’ in FIG. 2) 230, a processor (abbreviated as ‘MPU’ in FIG. 2) 240, a cache memory 250, a memory 260, a bridge 270, an encryption circuit 280, and a LAN interface 290, for example.

The host interface 210 controls communications with the host 500. Various commands and data sent by the host 500 are received by the host interface 210. A notice regarding the end of the processing of data and commands and so forth read from the storage devices 330A and 330B is transmitted from the host interface 210 to the host 500.

The backend controller 220 controls communications with the respective storage devices 330A and 330B. The backend controller 220 performs an operation to convert the logical block address (LBA) and the physical addresses of the storage devices 330A and 330B.

The data transfer control circuit 230 is a circuit for controlling the transfer of data in the controller 200. The data transfer control circuit 230 controls the transfer of data between the host interface 210 and the cache memory 250 and the transfer of data between the backend controller 220 and cache memory 250.

The processor 240 comprises one or a plurality of processor cores. The processor 240 implements various functions (described subsequently) by reading and executing programs stored in the memory 260.

The cache memory 250 stores data read received from the host 500 and data read by the host 500. In addition to user data which is write data and read data, a variety of information relating to encryption that is performed within the storage control device 100 is also stored in the cache memory 250. Information relating to encryption is an encryption key 251, an encryption data address management table 252, an LU (Logical Unit) management table 253, and an encryption judgment table 254. The encryption key 251 is used in order to encrypt data in the storage control device 100 and restore the encrypted data to plain data. Tables 252, 253, and 254 will be described subsequently together with other drawings.

The memory 260 stores programs and control information. The memory 260 stores programs for implementing a variety of functions such as the encryption/decrypting judgment section 261, the encryption processing section 262, the decrypting processing section 263, an encryption key generation section 264, and an LU setting section 265, for example. All or part of the programs for implementing these respective functions may be transferred from the storage devices 330A and 330B to the memory 260 during startup of the storage control device 100.

The encryption/decrypting judgment section 261 is a function for judging whether to encrypt write data received from the host 500 and whether to decrypt data requested by the host 500.

The encryption processing section 262 performs encryption processing by using the encryption circuit 280 for data for which encryption has been determined by the encryption/decrypting judgment section 261. Likewise, the decrypting processing section 263 performs decrypting processing by using an encryption circuit 280 for data for which decrypting has been determined by the encryption/decrypting judgment section 261. The encryption key generation section 264 generates an encryption key for use in the encryption processing and decrypting processing. The LU setting section 265 is a function for generating storage devices 330A and 330B, setting attributes for the encryption of the storage devices 330A and 330B (classification as an encryption storage region or non-encryption storage region), and setting the connective relationship and so forth between the storage devices 330A, 330B and the host 500. These settings are made by the user via the management terminal 400.

The bridge 270 connects the processor 240 and memory 260. Further, the processor 240 is connected to the data transfer control circuit 230 via the bridge 270.

The encryption circuit 280 is a circuit for encrypting plain data and decrypting encryption data. The encryption circuit 280 is controlled by the encryption processing section 262. The encryption circuit 280 can be provided between the data transfer control circuit 230 and backend controller 220 as illustrated in FIG. 2, for example. Alternatively, the constitution may be such that the encryption circuit 280 is provided between the data transfer control circuit 230 and the host interface 210 or such that the encryption circuit 280 is provided in the data transfer control circuit 230, for example. The LAN interface 290 may communicate with the management terminal 400.

The constitution of the storage device mount section 300 will now be described. The storage device mount section 300 comprises a plurality of storage devices 330A and 330B. The first storage device 330A is set with a non-encryption storage region attribute and stores plain data. The other storage device 330B is set with an encryption storage region attribute and stores encryption data. Further, with the exception of cases where a particular distinction is made, the storage devices 330A and 330B are expressed as the storage device 330 in the following description.

The constitution of the storage device 330 will now be described. First, a RAID group 320 is constituted by one or a plurality of physical storage devices 310. In order to prevent confusion with the logical storage devices 330, the physical storage devices 310 are expressed as disk drives 310 and the logical storage devices 330 are expressed as LU or logical volumes hereinbelow. Further, the LU 330 set as encryption storage regions are sometimes expressed as encryption LU in FIG. 2. Further, the disk drives 310 are constituted as hard disk drives, for example, but are not limited thereto. The disk drives 310 may also be constituted by a semiconductor memory device or the like.

The RAID group 320 is constructed by grouping a physical storage region that a plurality of disk drives 310 comprise. An LU 330 can also be provided in the storage region of the RAID group 320.

Further, the above hardware constitution is an example and the present invention is not limited to this constitution. The constitution may also be such that data can also be written and read to and from the LU 330A and 330B in accordance with commands from the host 500, configuration relating to encryption can be updated on the basis of instructions from the management terminal 400, and data can be encrypted or decrypted within the storage control device 100.

FIG. 3 is an explanatory diagram that shows an example of the settings screen G1 displayed on the management terminal 400. The user performs a variety of encryption-related settings by calling the settings screen G1. That is, the settings screen G1 is a user interface for setting the encryption judgment table 254 and LU management table 253 respectively.

The settings screen G1 contains a plurality of setting items G11 to G15 and buttons G16 and G17, for example. Respective names are displayed for the setting items have and the user inputs or selects values set for the items.

The number (LUN: Logical Unit Number) of the LU 330 to be set is set in the LUN setting item G11. The number of the host 500 that is associated with the LU 330 set in G11 is set in the host setting item G12. Here, numbers for identifying each of the hosts 500 are preset for the respective hosts 500. Instead of host numbers, preset nicknames or the like can also be used for the respective hosts 500.

Units to be encrypted are set in the encryption unit setting item G13. Encryption units can include, for example, host units, OS units, an application program units, and so forth. ‘AP’ in FIG. 3 is an abbreviation for ‘application program’.

The number of the RAID group 320 that comprises LU 330 that is set in G11 is set in the RAID group setting item G14. The user selects any one RAID group 320 on the basis of the blank capacity of the RAID group 320 and the performance of the disk drive 310 constituting the RAID group 320, for example. In the encryption-performance operation setting item G15, a setting is made with regard to whether to use LU 330 set in G11 as an encryption storage region. When ‘ON’ is set in item G15, the LU 330 set in G11 is used as an encryption storage region. When ‘OFF’ is set in item G15, the LU 330 set in G11 is used as a non-encryption storage region.

When the setting of the respective setting items G11 to G15 is complete, the user operates the finalization button G16. As a result, the values set in the respective setting items G11 to G15 are reflected in the tables 253 and 254. Meanwhile, the user operates the cancel button G17 when the set values thus input are to be cancelled.

Further, the set items above may be increased or reduced. That is, items other than the items shown in FIG. 3 can also be added in accordance with the conditions to be set for the storage control device 100 or a portion of the items shown in FIG. 3 can also be removed. Further, instead of a graphical user interface, another user interface such as a user interface in which set values are entered from a command line, for example, may also be adopted.

FIG. 4 is an explanatory diagram showing an example of an encryption judgment table 254.

The encryption judgment table 254 stores information for judging whether to encrypt data received from the host 500 in the storage control device 100. The encryption judgment table 254 associates and manages host identification information (host#) 2541, a reception data type 2542, a storage encryption function usage existence 2543, and a unit for encryption 2544, for example.

The host identification information 2541 is information for identifying the respective hosts 500 contained in the storage system. A number, WWN (World Wide Name) and IP address and so forth that are preset for the each host 500, for example, are used as host identification information. The information may be information that allows the respective hosts 500 to be uniquely specified in the storage system.

The reception data type 2542 is information showing whether the data received from the host 500 has been encrypted. When the data received from the host 500 has been encrypted, the reception data type 2542 is set as ‘encryption data’ and, when the data received from the host 500 has not been encrypted, the reception data type 2542 is set as ‘plain data’. Further, it may also be discriminated whether the data received from the host 500 is encryption data. Hence, arbitrary values can be used such that ‘1’ is set in the case of encryption data and ‘0’ is set in the case of plain data, for example.

The storage encryption function 2543 is information indicating whether to operate the encryption function that the storage control device 100 has. In FIG. 4, the storage control device 100 is expressed simply as ‘storage’. When data encryption processing is performed in the storage control device 100, ‘ON’ is set. When data encryption processing is hot performed in the storage control device 100, ‘OFF’ is set. Because it is possible to discriminate whether the encryption function in the storage control device 100 is used, arbitrary values can be used.

The encryption unit 2544 is information indicating the execution unit when encrypting data in the storage control device 100. The encryption unit is selected by the user from among preset values. Values such as ‘host’, ‘application program’ and so forth, for example, are prepared beforehand as encryption units. When ‘host’ is set as the encryption unit, the storage control device 100 encrypts all the data received from the set host 500 in the storage control device 100. When the name ‘application program’ is set as the encryption unit, the storage control device 100 encrypts the received data related to the set application program 530 in the storage control device 100.

Further, the unit for performing encryption processing in the storage control device 100 is not limited to the abovementioned ‘host’ or ‘application program’. The controller 200 of the storage control device 100 may also be an identifiable unit. For example, as per the subsequent embodiment, control of whether encryption processing is performed in file units is also possible.

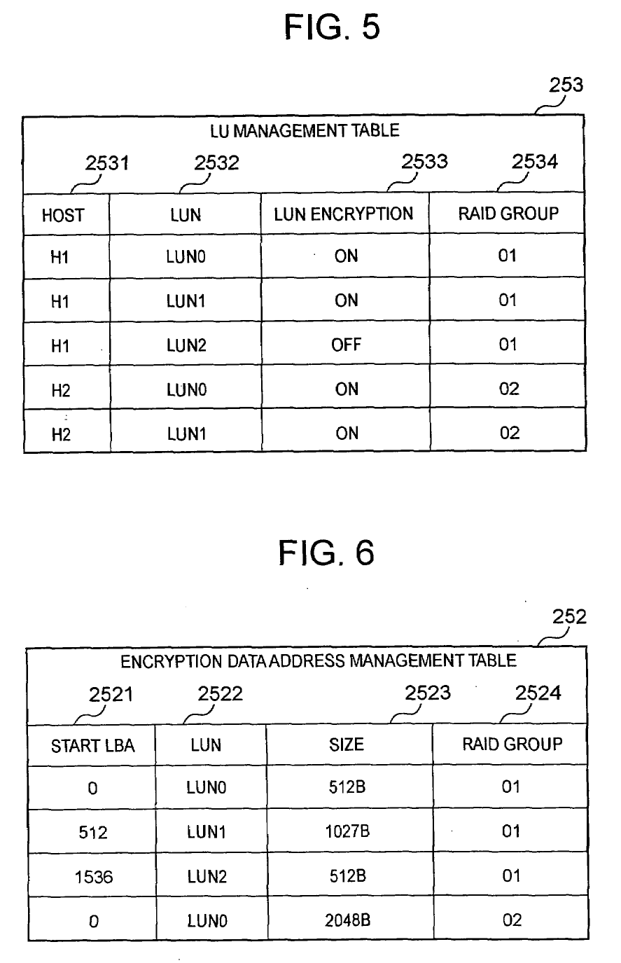

FIG. 5 is an explanatory diagram showing an example of the LU management table 253. Information for managing each LU 330 is stored in the LU management table 253. The LU management table 253 associates and manages host identification information 2531, an LUN 2532, an LU encryption existence 253, and RAID group identification information 2534, for example.

The host identification information 2531 is the same as the host identification information 2541 above. The LUN (Logical Unit Number) 2532 is information for designating the LU 330 allocated to the host 500 specified by the host identification information 2531. The LU encryption 2533 is information for setting whether the LU 330 designated by the LUN is used as an encryption storage region. An LU 330 for which ‘ON’ is set is used as an encryption storage region and data of which LU 330 is the subject is encrypted in the storage control device 100 and therefore written to the LU 330. An LU 330 for which ‘OFF’ has been set is used as a non-encryption storage region and the data of which LU 330 is the subject is not encrypted in the storage control device 100 and stored as is in the state received.

The RAID group identification information 2534 is information that designates the RAID group 320 to which the LU 330 designated by the LUN2532 belongs. The user selects a preferred RAID group 320 on the basis of the characteristics and blank capacity and so forth of the RAID group 320 and generates the LU 330. The generated LU 330 is associated with a specified host 500 and the communication channel with the host 500 is defined.

Thus, the LU management table 253 is able to manage the storage regions in the storage control device 100 by dividing same into regions for performing encryption processing (encryption storage region) and regions in which encryption processing is not performed (non-encryption storage region).

FIG. 6 is an explanatory diagram showing an example of the encryption data address management table 252. The encryption data address management table 252 stores information for managing the storage destination of the data encrypted in the storage control device 100. The encryption data address management table 252 associates and manages a start LBA 2521, a LUN 2522, a size 2523, and a RAID group 2524, for example.

The start LBA 2521 is information indicating the header address at which the encryption data are written and is set as the value of the LBA (Logical Block Address). The LUN252 is information specifying the write-destination LU 330 of the encryption data. The size 2523 is information showing the size of the written encryption data. The RAID group 2524 is information indicating the RAID group 320 to which the write destination LU 330 belongs.

Further, although the same is true of the other tables, the constitution of the respective tables may be a constitution other than that illustrated provided that the object of the present invention can be achieved.

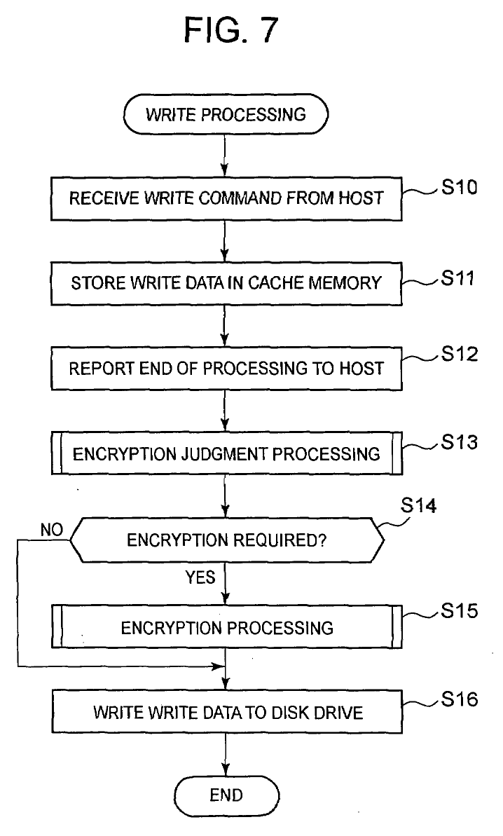

FIG. 7 shows a flowchart for processing a write command that is issued by the host 500. Although each of the following flowcharts are the same, each flowchart shows an overview of the processing and therefore sometimes differs from the actual computer program. Further, in the following description, step is abbreviated as ‘S’.

When the storage control device 100 receives a write command from the host 500 (S10), write data are stored in the cache memory 250 (S11). Further, the storage control device 100 reports the fact that the processing of the write command is complete to the host 500 at the point where write data are stored in the cache memory 250 (S12).

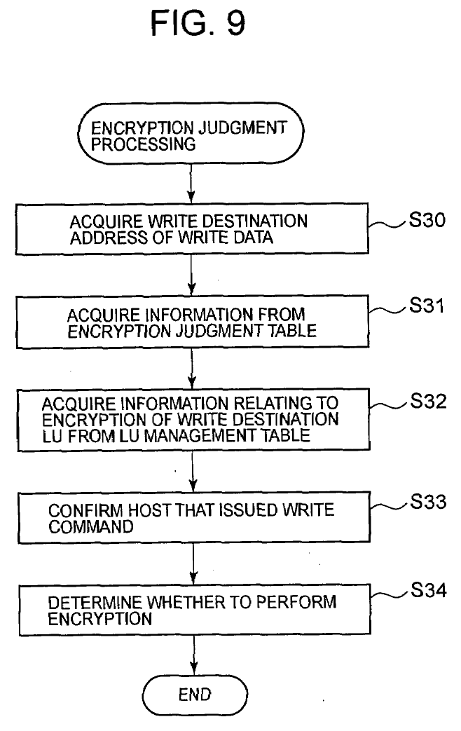

The storage control device 100 judges whether write data received from the host 500 are encrypted (S13). The details of the judgment processing S13 with respect to whether encryption is performed or not will be described subsequently in conjunction with FIG. 9.

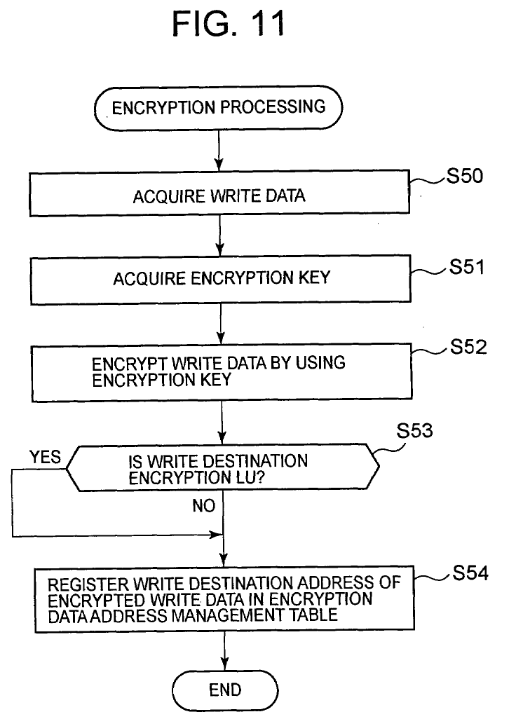

The storage control device 100 judges whether encryption of the write data is required on the basis of the judgment result of S13 (S14). When it is judged that encryption of the write data is required (S14:YES), the storage control device executes encryption processing (S15). The details of the encryption processing will be described subsequently in conjunction with FIG. 11. Further, the constitution may be such that it is judged whether to encrypt write data prior to storing write data in the cache memory 250. That is, S13 can also be executed prior to S11.

After encrypting the write data in the storage control device 100, the storage control device 100 stores the write data thus encrypted in the disk drive 310 that constitutes the write destination LU 330 (S16).

On the other hand, when it is judged that encryption of the write data is not required (S14:NO), the storage control device 100 stores the write data in the disk drive 310 constituting the write destination LU 330 without performing encryption processing.

Further, the constitution may be such that notice of the completion of write command processing is sent to the host 500 at the point where the write data are written to the disk drive 310. Further, the processing to write encrypted write data to the disk drive 310 (also called de-stage processing) can be performed at a time when the load of the storage control device 100 is relatively small.

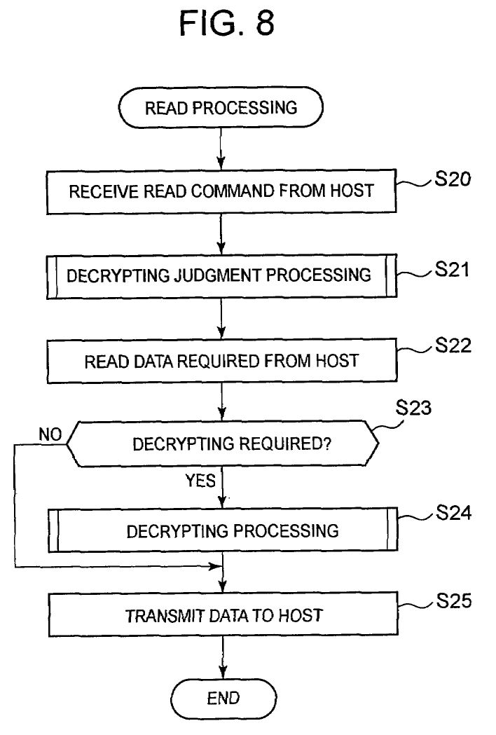

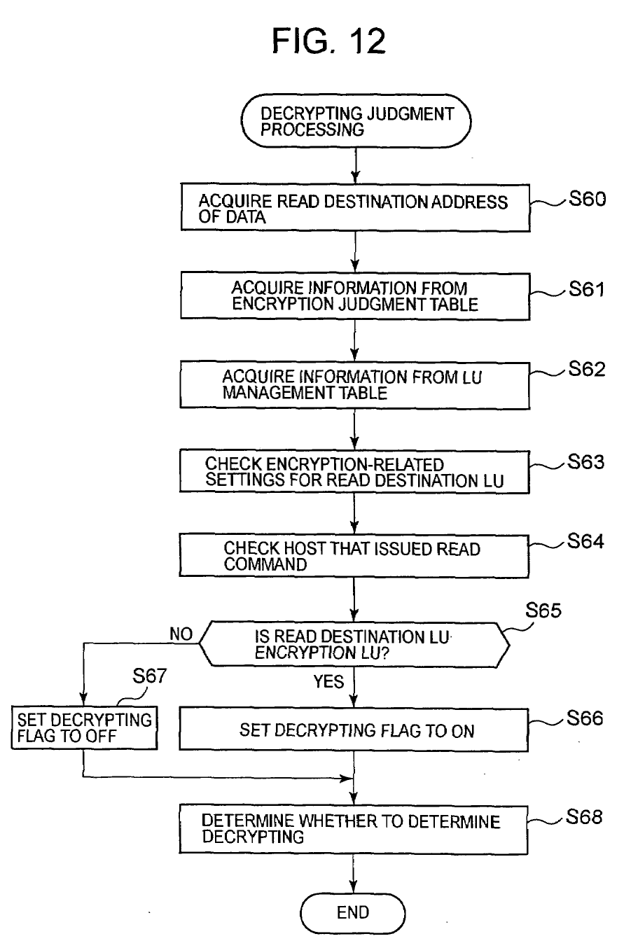

FIG. 8 is a flowchart for processing a read command issued by the host 500. Upon receipt of the read command from the host 500 (S20), the storage control device 100 judges whether read target data requires decrypting in the storage control device 100 (S21). The processing S21 for judging whether the decrypting is required will be described subsequently in conjunction with FIG. 12.

The storage control device 100 reads the data requested by the host 500 to the LU 330 designated as the read destination (S22). The storage control device 100 judges whether the data ‘thus’read is decrypted on the basis of the judgment result of the S21 (S23).

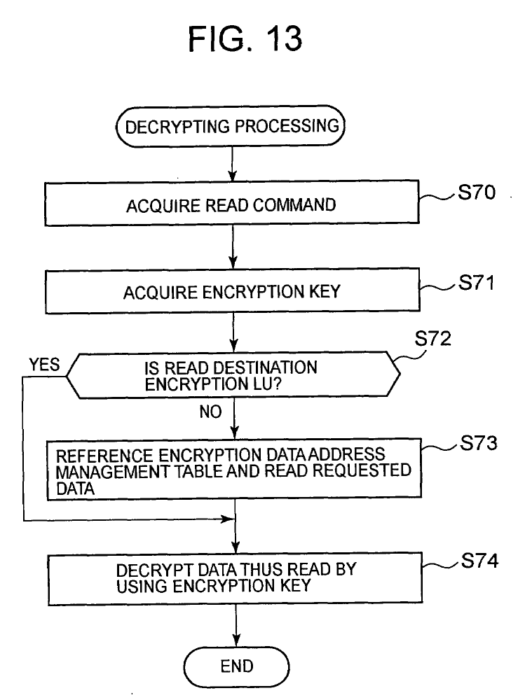

When it is judged that decrypting of the data thus read is required (S23:YES), the storage control device 100 executes decrypting processing (S24). The decrypting processing will be described subsequently in conjunction with FIG. 13. Further, the storage control device 100 transmits the decrypted data to the host 500 (S25).

Further, the target of the decrypting processing is data that has been encrypted in the storage control device 100. Therefore, when data whose reading has been requested by the host 500 is encrypted in the host 500 and storage control device 100 respectively, even when decrypting processing is executed in the storage control device 100, the encryption data naturally remain as encryption data. The data encrypted by the host 500 is decrypted by the host 500.

FIG. 9 is a flowchart showing a first example of the encryption judgment processing. This processing corresponds to S13 in FIG. 7. This processing is applied to cases where it is determined beforehand whether to use each LU 330 used by the respective hosts 500 as an encryption storage region. As mentioned earlier, the user is able to establish in advance whether to perform encryption processing with respect to an association between the host 500 and LU 330.

The storage control device 100 acquires the write destination address of the write data on the basis of a write command (S30). The storage control device 100 acquires set information relating to the encryption of write data from the encryption judgment table 254 (S31). Thereafter, the storage control device 100 acquires encryption-related information of the LU 330 designated as the write destination from the LU management table 253 (S32). Furthermore, the storage control device 100 checks what kind of host the host 500 that issued the write command is (S33).

Further, the storage control device 100 judges whether to encrypt the write data on the basis of the information obtained in S31, S32, and S33 and terminates the processing (S34).

More specifically, for example, when a determination that the encryption function in the storage control device 100 is preset for all of the hosts 500 that issue write commands, it is judged that the encryption of write data received from the host 500 is required. Further, in cases where the encryption unit is an application program, for example, when it is established in advance to perform encryption processing in the storage control device 100 with respect to the application program 530 that creates write data, the encryption of the write data is judged as being necessary. Furthermore, when it is established beforehand to use the write destination LU 330 of the write data as an encryption storage region, for example, it is judged that the write data written to the LU 330 requires encryption.

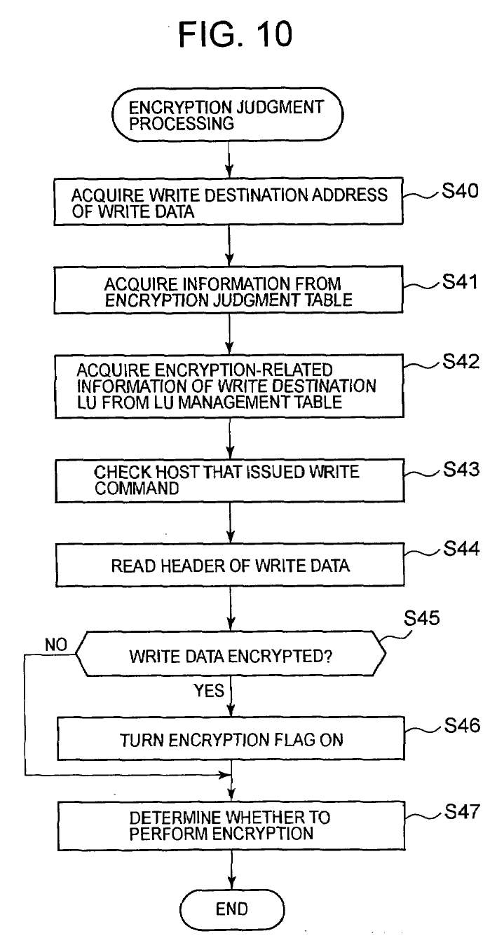

FIG. 10 is a flowchart showing the second example of encryption judgment processing. This processing is another example that corresponds to S13 in FIG. 7. This processing is as detailed hereinbelow and the storage control device 100 discriminates whether the write data received from the host 500 has been encrypted.

S40 to S43 of this processing are the same as S30 to S33 in FIG. 9 and, therefore, a repeated description is omitted. In this embodiment, after confirming the host 500 which was the source of the write command (S43), the storage control device 100 reads the header part of the write data (S44) and judges whether the data are encrypted data (S45). The storage control device 100 judges whether the write data has been encrypted by analyzing the pattern of the bit string of the header, for example.

When it is judged that the write data has been encrypted (S45;YES), the storage control device 100 sets the encryption flag to ON (S46). The encryption flag is information indicating whether the write data are data that has been encrypted by the host 500. When the encryption flag is set to ON, this indicates that the write data are encryption data. When the encryption flag is OFF, this indicates that the write data are plain data.

The storage control device 100 judges whether the encryption of the write data is required on the basis of value of the encryption flag and the setting content of the encryption judgment table 254 (S47). As mentioned earlier, the operations policy with respect to whether to encrypt the write data or not encrypt the write data is preset by the user for each unit to be encrypted in the encryption judgment table 254.

For example, when plain data are received for a certain host (or application program or the like), it is supposed that a policy to the effect that the encryption function in the storage control device 100 is to be used is registered. In this case, when the storage control device 100 judges that the received write data are plain data, it is judged that encryption processing of the write data is required. When it is judged that the received write data are encryption data, the storage control device 100 judges that encryption processing of the write data is not required.

FIG. 11 is a flowchart of the encryption processing indicated in S15 in FIG. 7. The storage control device 100 acquires the write data (S50) and acquires the encryption key 251 stored in the cache memory 250 (S51). The storage control device 100 encrypts the write data by using the encryption key 251 (S52).

The storage control device 100 judges whether the write destination LU 330 is set as the encryption storage region on the basis of the write destination address of the write data (S53). When the write-destination LU 330 is set as the encryption storage region (S50:YES), the storage control device 100 ends the processing.

On the other hand, when the write-destination LU 330 is set as a non-encryption storage region (S50:NO), the storage control device 100 registers the start LBA 2521 and size 2523 and so forth of the encrypted write data in the encryption data address management table 252 (S54). Thus, the storage control device 100 manages the information relating to the storage destination of the encrypted data by writing same in the table 252 when data encrypted in the storage control device 100 is stored in the LU 330 that is set as a non-encryption storage region.

When a policy for preventing repeated encryption processing is established, for example, encryption data received from the host 500 are stored in the LU 330 in an as is state. However, sometimes there is a limit on the encryption function in the host 500 and a portion of the data cannot be encrypted. In this case, encryption data and plain data are transmitted in mixed fashion by the host 500. As described in the processing of FIG. 10, the storage control device 100 is able to discover plain data by analyzing the header of the write data. The storage control device 100 encrypts the discovered plain data in the storage control device 100 and stores this data in the LU 330. Thereupon, the position of the encrypted data in the storage control device 100 is stored in the table 252. As a result, when reading is requested by the host 500, the data encrypted in the storage control device 100 can be decrypted in the storage control device 100 and transmitted to the host 500.

FIG. 12 is a flowchart for the decrypting judgment processing shown in S21 in FIG. 8. The storage control device 100 acquires the reading destination address of the data whose reading was requested by the host 500 on the basis of a read command (S60).

The storage control device 100 acquires encryption-related configuration from the encryption judgment table 254 (S61). Thereafter, the storage control device 100 acquires encryption-related information of the reading-destination LU 330 from the LU management table 253 (S62) and checks whether the reading destination LU 330 is an encryption storage region (S63). In addition, the storage control device 100 checks which host 500 is the source of the read command (S64).

The storage control device 100 judges whether the read destination LU 330 is an encryption storage region (S65). When the read destination LU 330 is an encryption storage region (S65:YES), the storage control device 100 sets the decrypting flag to ON (S66). The decrypting flag is information that indicates whether data are decrypted. The decrypting flag is set to ON for data that is to be decrypted. The decrypting flag is set to OFF for data not requiring decrypting processing (S67).

Ultimately, the storage control device 100 judges whether to implement decrypting processing on the basis of the value of the decrypting flag (S68) and terminates the processing. That is, the storage control device 100 determines whether to perform decrypting in the storage control device 100 for data that has been encrypted in the storage control device 100.

FIG. 13 is a flowchart for decrypting processing shown in S24 in FIG. 8. The storage control device 100 acquires a read command from the host 500 (S70) and then acquires an encryption key 251 used for encryption of the encryption data for which reading has been requested from the cache memory 250 (S71).

The storage control device 100 judges whether the read-destination LU 330 has been set as an encryption storage region (S72). When the read-destination LU 330 has been set as a non-encryption storage region (S72:NO), the storage control device 100 acquires the address where the read-target data are stored from the encryption data address management table 252 and reads the data requested by the host 500 on the basis of the address (S73). When the read-destination LU 330 is an encryption storage region (S72:YES), S73 is skipped. Thereafter, the storage control device 100 decrypts the encryption data thus read from the LU 330 by using the encryption key 251 acquired in S71 (S74) and ends the processing.

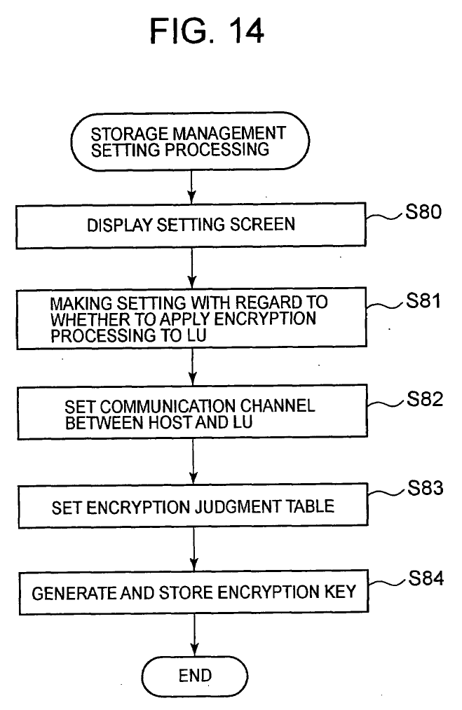

FIG. 14 is a flowchart showing processing for registering encryption-related setting values from the management terminal 400 to the storage control device 100. The user activates the storage management software 410 of the management terminal 400 and calls the screen for setting the variety of information relating to the LU 330 (S80).

The user initially establishes whether the LU 330 is used as an encryption storage region (S81). Thereafter, the user sets the communication channel between the host 500 and LU 330 (S82) and allocates LU 330 to the host 500. The setting content of S81 and S82 is registered in the LU management table 253.

In addition, the user sets the encryption judgment table 254 with respect to the type of data received from the host 500, whether the encryption function in the storage control device 100 is used, and with regard to the unit of encryption by calling a setting screen of the type shown in FIG. 3 (S83). Ultimately, the user generates an encryption key 251 by using the function of the storage management software 410 and registers the encryption key 251 thus generated in the cache memory 250 (S84).

The operation of the storage control device 100 according to this embodiment was detailed hereinabove. Further, as mentioned earlier, the host 500 sometimes comprises a function for performing encryption in various units. For example, sometimes the OS 520, application program 530, or database has an encryption function.

For example, in the case of the application program 530 whose purpose is data encryption, specified folders and files of the file system are set as targets for encryption and folders and files and so forth not requiring encryption are set as non-encryption targets and operates according to the settings. The type and unit of the encryption function that the host 500 comprises is not restricted in this embodiment.

The hosts 500 differ according to the operating environment and operating policy or the like of the information system of the user depending on whether the host 500 has an encryption function. Further, even when the storage control device 100 has an encryption function, it is possible that the range in which data can be protected through encryption will differ between the host 500 and storage control device 100. Hence, a case where the encryption function operates repeatedly in the host 500 and the storage control device 100 is also assumed. If encryption is not required from the perspective of the importance and confidentiality of data, a constitution that does not have an encryption function or an operation where an encryption function is provided but not used is assumed.

Generally, in the case of encryption using software, the processing speed varies depending on the hardware performance of the host 500 and the load applied to the CPU also increases. Hence, when encryption processing is performed by a low-spec host 500, there is a particular link with a drop in the performance of the host 500. Irrespective of the specifications of the host 500, when the host 500 is charged with the encryption processing, the encryption processing load increases. Hence, this results in a drop in the processing performance of the application program 530 and a drop in work efficiency. Therefore, when performance is considered, the method of assigning the encryption processing in the storage control device 100 is efficient.

On the other hand, as a result of performing encryption within the host 500, the encryption data are transmitted to the outside by the host 500. Hence, data can be protected from theft such as interception and encryption in the host 500 is superior from the standpoint of stability.

Thus, in a storage system or information system, where the encryption takes place differs according to the quality of the data and the operating policy and so forth.

Further, this embodiment is adapted to be able to control whether encryption processing is executed in the storage control device 100 depending on whether the data received from the host 500 is encryption data or plain data. As a result, a situation where encryption data received from the host 500 is further encrypted in the storage control device 100 can be prevented. Therefore, a drop in the performance of the storage control device 100 can be suppressed.

Furthermore, in this embodiment, the constitution is such that the user is able to establish an encryption-related policy in advance and the storage control device 100 controls the encryption function on the basis of the policy set by the user. As a result, the user is able to store encryption data from the host 500 as is in the LU 330, store encryption data from the host 500 in the LU 330 after further encrypting same in the storage control device 100, store plain data from the host 500 in the LU 330 after encrypting same in the storage control device 100, and store plain data from the host 500 as is in the LU 330, for example. Therefore, a flexible operation is possible depending on the desires of the user and user convenience improves.

### Second Embodiment

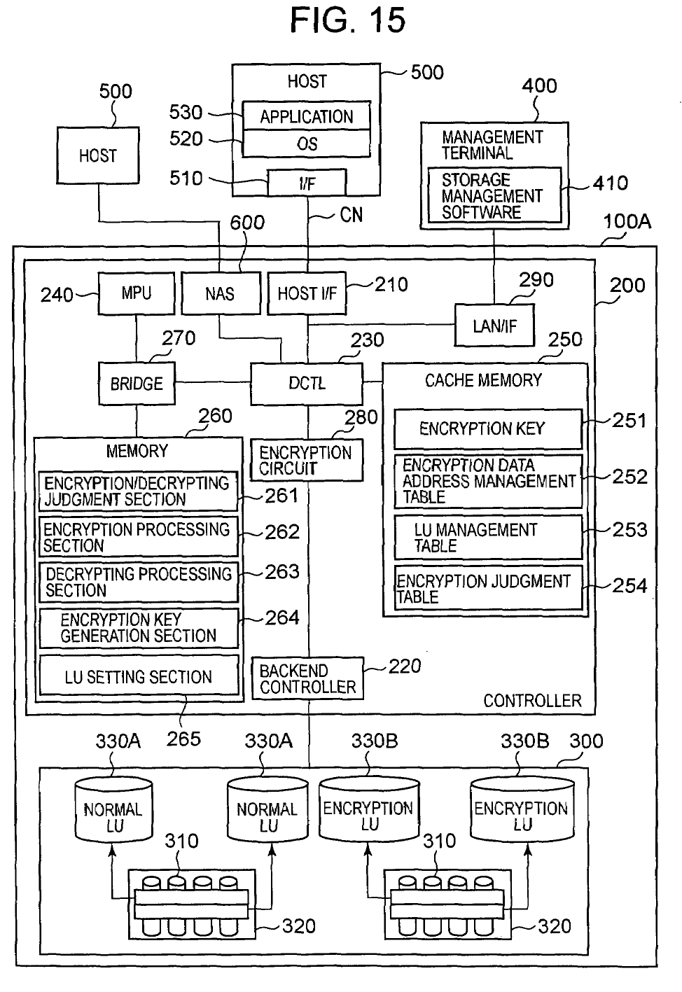

A second embodiment of the present invention will be described on the basis of FIGS. 15 to 17. The embodiments below including this embodiment each correspond to modified examples of the first embodiment. In the following description, a repeated description is omitted and mainly the characterizing parts are described. In this embodiment, the operation of the encryption function is controlled by a storage control device 100A which has NAS (Network Attached Storage) function.

FIG. 15 is an explanatory diagram that shows the overall constitution of the storage system that includes the storage control device 100A of this embodiment. The storage control device 100A of this embodiment comprises a NAS600 that manages files. The host 500 connected to the NAS600 is able to access the storage control device 100A in file units and input and output file data.

Further, certain types of OS520 sometimes do not have an encryption function. In addition, even when the application program 530 has an encryption function, there is a limit on the encryption range and sometimes data that cannot be encrypted exist.

In addition, the user sometimes also encrypts and saves important data and sometimes considers saving unimportant data as plain data without further processing. The user sometimes desires the encryption of specified files and folders and so forth. If the encryption function of the OS520 and application program 530 cannot be made to meet such user needs, data received from the host 500 can be subjected to encryption processing and saved in the storage control device 100A by using the encryption function in the storage control device 100A. This point is as described in this embodiment.

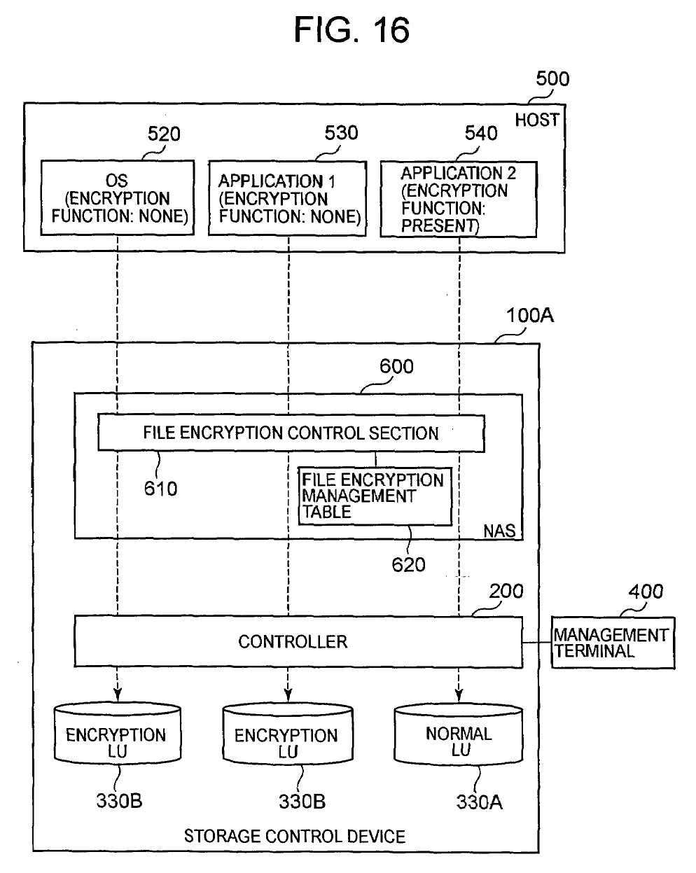

FIG. 16 is an explanatory diagram that schematically shows the functions and so forth of the NAS600. In this embodiment, in order to provide a NAS600 in the storage control device 100A, the encryption function in the storage control device 100A can be made to operate in file units. For example, file data that has been encrypted by the host 500 can be stored in the LU 330 as is without being subjected to encryption processing in the storage control device 100A. Further, file data that cannot be encrypted in the host 500 can be stored in the LU 330 after being encrypted in the storage control device 100A depending on the desires of the user. The NAS600 judges whether or not to encrypt the data received from the host 500.

The NAS600 comprises a control section 610 for controlling file encryption and a table 620 for managing information relating to the file encryption. The management table 620 manages metadata of data to which the NAS600 corresponds. Metadata includes information with regard to which storage region in the storage control device 100A the file data are stored in and whether file data are encrypted and stored, for example.

The control section 610 relating to encryption is able to check where and in what state the file data for which reading has been requested by the host 500 are stored by using the metadata managed by the management table 620. When the file data requested by the host 500 are encrypted via the NAS600, the NAS600 transmits the requested encryption data to the host 500 after encrypting same.

As a result, as shown in FIG. 16, in this embodiment, plain file data received from the OS520 or application program 530 (‘application program 1’ in FIG. 16) that does not possess an encryption function can be encrypted via the NAS600. The file data encrypted by using NAS600 are stored in the LU 330 set as the encryption storage region.

On the other hand, when file data that has been encrypted by the application program 530 (‘application program 2’ in FIG. 16) that possesses an encryption function are received, the NAS600 stores the encrypted file data in the LU 330 as is without subjecting the data to encryption processing.

The NAS600 is able to perform encryption processing and decrypting processing of the file data by using the encryption processing section 262 and decrypting processing section 263 and so forth in the controller 200. The constitution is not limited to the foregoing constitution. A constitution in which the encryption processing section and decrypting processing section are provided in the NAS600 is also possible.

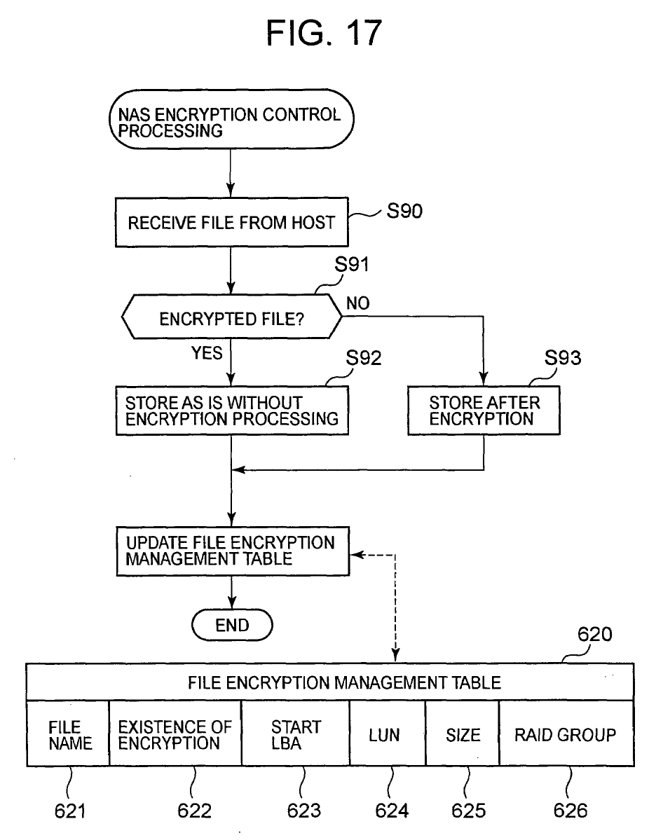

FIG. 17 is a flowchart showing the encryption control method of this embodiment. Upon receipt of file data from the host 500 (S90), the NAS600 judges whether these file data have been encrypted (S91). For example, the NAS600 is able to discriminate whether the file data are encryption data or plain data by analyzing the header part of the file data.

When it is judged that the file data received in S90 have been encrypted (S91:YES), the NAS600 stores the file data in the LU 330 as is without subjecting same to encryption processing (S92). On the other hand, when the file data received in S90 is judged to be plain data (S91:NO), the NAS600 stores the file data in the LU 330 after encrypting the file data (S93) The NAS600 then updates the management table 620 (S94) The management table 620 manages, for example, a file name 621, identification information 622 indicating the existence of encryption, a storage-destination start LBA623, a LUN 624, a size 625, and a RAID group 626, and so forth, as shown at the bottom of FIG. 17. The management table 620 may have a constitution capable of managing the storage location and the existence of encryption of file data that the NAS600 is charged with and the management item need not be restricted to that shown in FIG. 17.

Further, in the flowchart, a case where the file data received from the host 500 have been encrypted and are stored in the LU 330 as is and a case where the file data received from the host 500 have not been encrypted and are subjected to encryption processing before being stored in the LU 330 were described. However, as mentioned in this embodiment, the NAS600 is able to determine whether to perform encryption processing in accordance with the policy set by the user.

The embodiment constituted thus exhibits the same effects as those of the first embodiment. In addition, in this embodiment, encryption of the file units in the storage control device 100A can be controlled, whereby user convenience improves.

### Third Embodiment

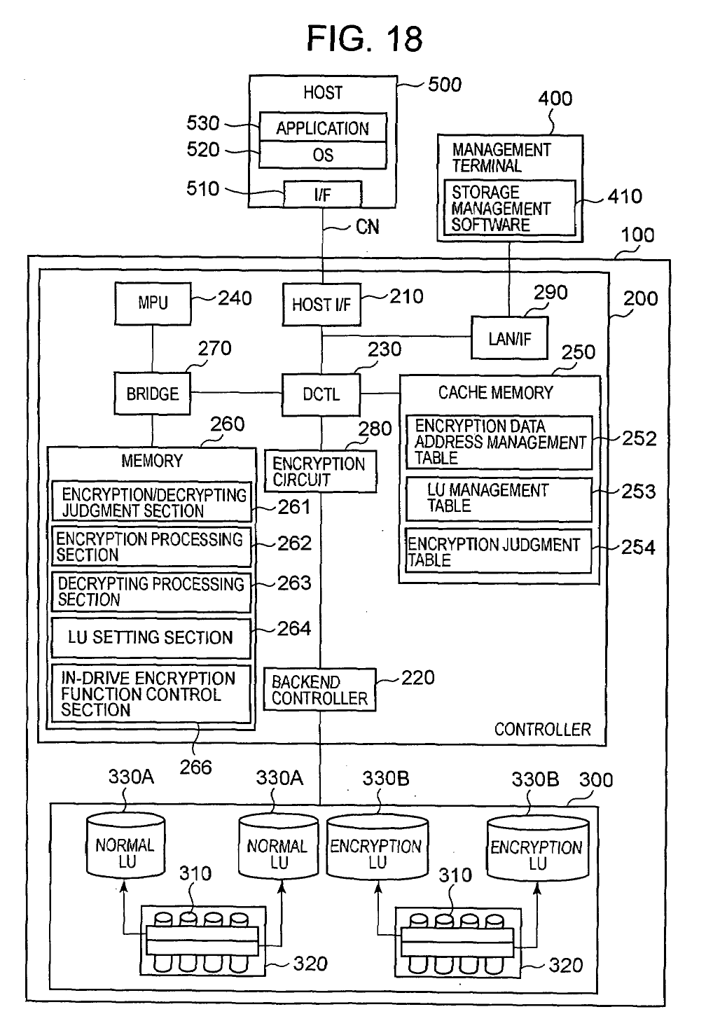

A third embodiment of the present invention will now be described on the basis of FIGS. 18 to 20. In this embodiment, data received by the host 500 are encrypted or decrypted by using the encryption function that the disk drive 310 possesses.

FIG. 18 is an explanatory diagram showing the constitution of the storage system comprising a storage control device 100B of this embodiment. The storage control device 100B of this embodiment comprises a control section 266 for controlling the encryption function of the disk drive 310 in the controller 200. In comparison with the first embodiment, this embodiment uses the encryption function in the disk drive 310 and, therefore, there is no need to manage the encryption key in the controller 200. The encryption key generation section 264 and encryption key 251 are therefore removed.

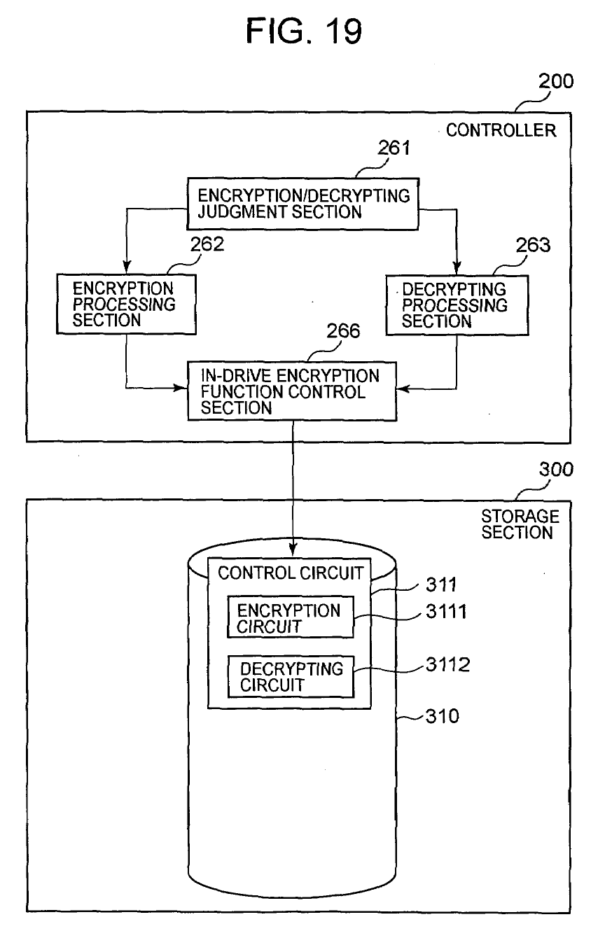

FIG. 19 is an explanatory diagram that shows an excerpt of the functions of the controller 200 and disk drive 310. The control circuit 311 of the disk drive 310 comprises an encryption circuit 3111 and a decrypting circuit 3112. The encryption circuit 3111 is a circuit for encrypting the data input to the disk drive 310. The decrypting circuit 3112 is a circuit for decrypting data output by the disk drive 310.

As per the first embodiment, the encryption/decrypting judgment section 261 determines whether to encrypt the data received from the host 500. When encryption is to be performed, the encryption/decrypting judgment section 261 issues an instruction to encrypt data to the encryption processing section 262. When decrypting is to be performed, the encryption/decrypting judgment section 261 issues an instruction to decrypt the data to the decrypting processing section 263.

The in-drive encryption function control section 266 validates the encryption function in the disk drive 310 in accordance with an instruction from the encryption processing section 262 and encrypts data that are input to the disk drive 310 in the disk drive 310. On the other hand, when it is judged by the encryption/decrypting judgment section 261 that encryption is not required, the control section 266 invalidates the encryption function in the disk drive and stores data that are input to the disk drive 310 as is without encrypting these data.

The decrypting processing section 263 is able to decrypt and output encryption data stored in the disk drive 310 by using the encryption function in the disk drive 310. Not being limited to such an operation, the decrypting processing section 263 is also able to decrypt encryption data in the controller 200 by acquiring the encryption key used in the encryption in the disk drive 310 from the disk drive 310.

Further, in this embodiment, in order to use the encryption function in the disk drive 310, the encryption key is basically stored in the disk drive 310. However, the constitution is not limited to such an arrangement and may also be such that the encryption key is saved in the controller 200 or management terminal 400 or the like.

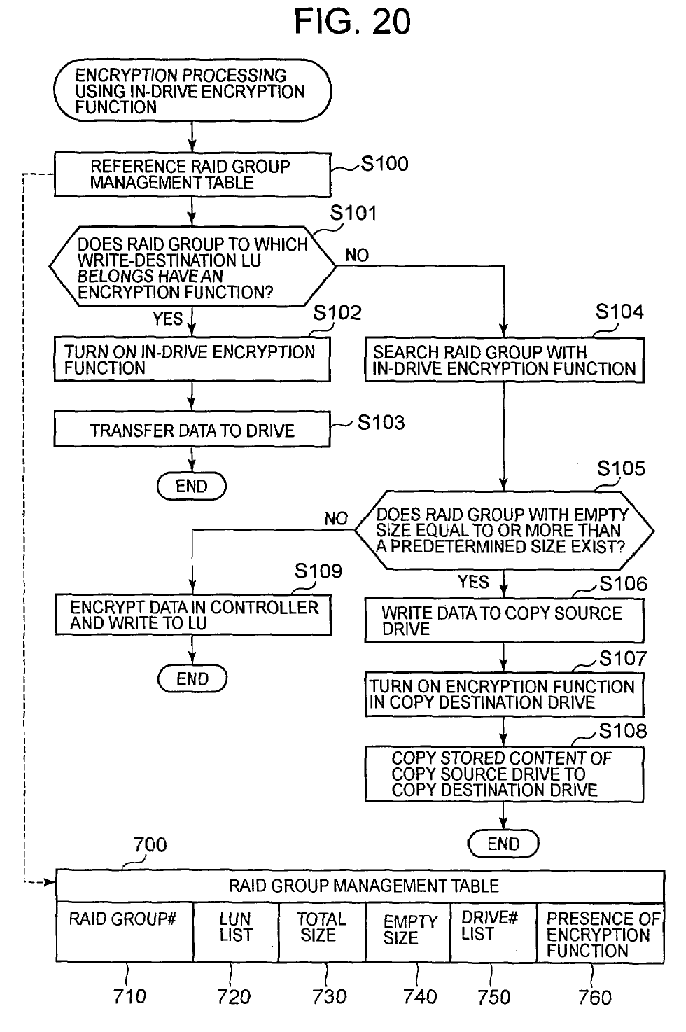

FIG. 20 is a flowchart that shows the operation in a case where data received from the host 500 are encrypted by using an encryption function in the disk drive 310. The storage control device 100B references the RAID group management table 700 (S100) and judges whether the RAID group 320 to which the write destination LU 330 belongs comprises an encryption function (S101).

The RAID group management table 700 shown at the bottom of FIG. 20 serves to manage the respective RAID groups 320 of the storage control device 100. The management table 700 associates and manages, for example, a RAID group number 710, a LUN list 720, a total size 730, an empty size 740, a drive number list 750, and identification information 760 that indicates the presence of an encryption function.

The RAID group number 710 is information serving to identify each of the RAID groups 320. The LUN list 720 is information for specifying the LU330 that are provided in the RAID group 320. The total size 730 indicates the size of the whole storage region of the RAID group 320. The empty size 740 indicates the size of the unused storage region of the RAID group 320. The drive number list 750 is information for specifying the disk drives 310 that constitute the RAID group 320. The information 760 that indicates the existence of an encryption function is information indicating whether the respective disk drives 310 that constitute the RAID group 320 comprise an encryption function.

Let us now return to the description of the flowchart. When it is judged that the disk drive 310 relating to the write destination LU 330 has an encryption function (S101:YES), the storage control device 100B sets the encryption function of the disk drive 310 as valid (ON) (S102). The storage control device 100B transfers data to the disk drive 310 (S103). As a result, the disk drive 310 encrypts and stores the data thus input in the disk drive 310.

On the other hand, when it is judged that the disk drive 310 relating to the write destination LU 330 does not comprise an encryption function (S101:NO), the storage control device 100B performs a search to determine whether another RAID group 320 constituted by the disk drives 310 that comprises an encryption function exists (S104).

The storage control device 100B judges whether a RAID group 320 that has an empty size equal to or more than a predetermined size exists (S105). ‘Predetermined size’ signifies a size equal to or more than the size of the write-destination LU 330.

When a RAID group 320 that comprises an empty size equal to or more than the predetermined size and in which a disk drive 310 comprising an encryption function is found (S105:YES), the storage control device 100B moves the installation location of the write-destination LU 330 to the RAID group 320 with the encryption function as detailed hereinbelow. In the following description, the disk drive 310 constituting the initial write target LU 330 (disk drive not comprising an encryption function) is the copy source drive called and the disk drive 310 to which data are copied from the copy source drive is called the copy destination drive. The copy destination drive contains an encryption function.

The storage control device 100B sets the encryption function of the copy destination drive to valid (S107) after writing write data received from the host 500 to the copy source drive (S106). The storage control device 100B then transfers the data stored in the copy source drive to the copy destination drive (S108). The copy destination drive stores data input from the copy source drive while encrypting these data.

When a RAID group 320 that has an empty size equal to or more than the predetermined size and in which a disk drive 310 comprises an encryption function is not found (S105:NO), the storage control device 100B encrypts write data received from the host 500 in the controller 200 and stores these data in the write-destination LU 330 (S109).

Further, the constitution may also be such that the processing moves to S108 when the judgment of S101 yields ‘NO’. That is, the constitution may be such that data are encrypted in the controller 200 and written to the disk drive 310 without being copied from the disk drive 310 without an encryption function to the disk drive 310 comprising an encryption function.

The embodiment constituted in this way exhibits the same effects as those of the first embodiment. In addition, because the encryption function of the disk drive 310 is used in this embodiment, the encryption-related load of the controller 200 can be lightened and a drop in the performance of the controller 200 can be suppressed.

### Fourth Embodiment

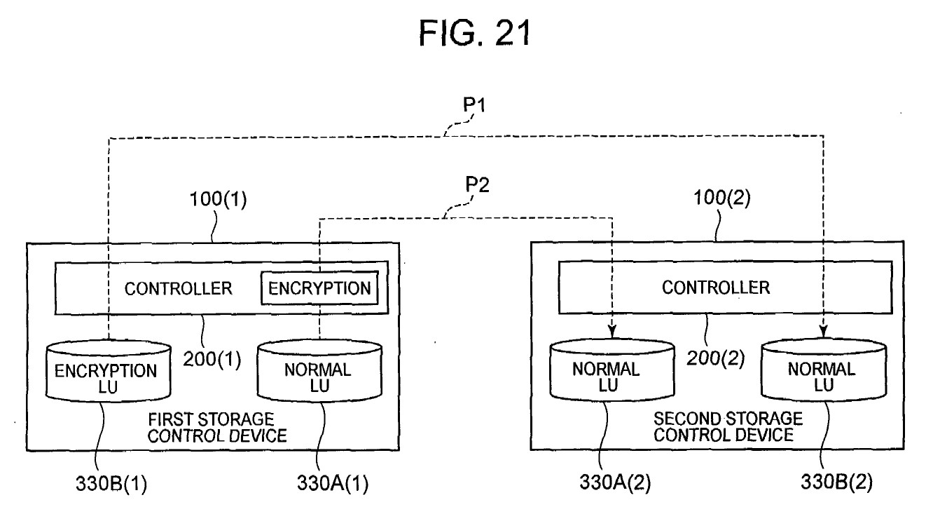

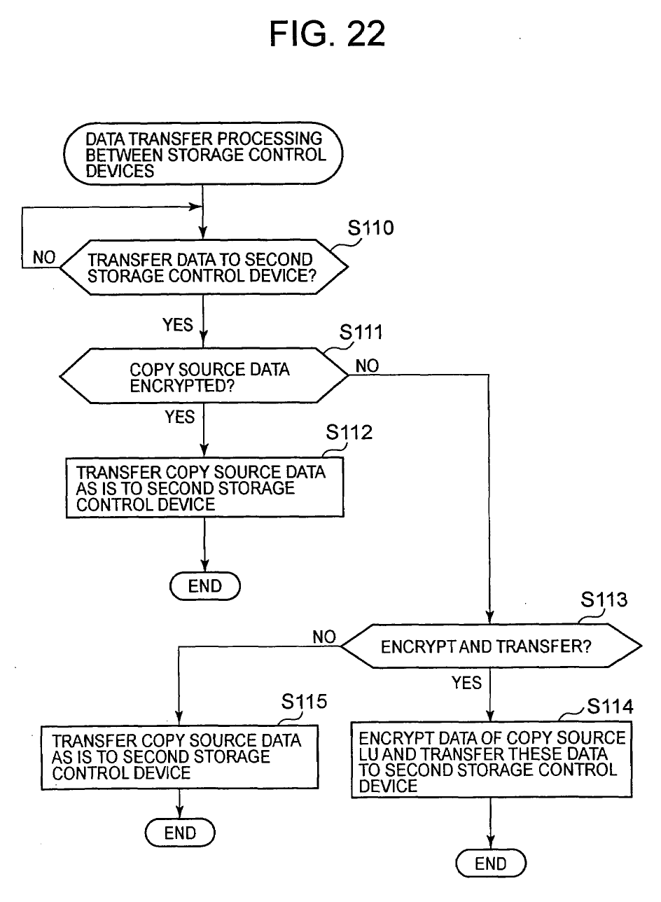

The fourth embodiment of the present invention will now be described based on FIGS. 21 and 22. In this embodiment, when data are transferred between a plurality of storage control devices 100(1) and 100(2), control of whether to encrypt the data is exercised.

FIG. 21 is an explanatory diagram that schematically shows a storage system comprising storage control devices 100(1) and 100(2) according to this embodiment. The respective storage control devices 100(1) and 100(2) have the same constitution as that of the storage control device 100 mentioned in the first embodiment.

For example, as per cases where a backup of the LU 330 is created and a duplicate of LU 330 is created, the data in the first storage control device 100(1) is sometimes transferred to the second storage control device 100(2).

In FIG. 21, an LU 330 that is set as a non-encryption storage region is shown as a ‘normal LU’ and an LU 330 that is set as an encryption storage region is shown as an ‘encryption LU’.

For example, in this embodiment, after plain data stored in the normal LU 330A(1) in the first storage control device 100(1) has been encrypted in the first storage control device 100(1), the encryption data can be transferred to the second storage control device 100(2). The second storage control device 100(2) stores the encryption data received from the first storage control device 100(1) in the normal LU 330A(2) as is without subjecting the data to encryption processing.

Further, the first storage control device 100(1) is also able to transfer the encryption data stored in the encryption LU 330B(1) to the second storage control device 100(2), for example. In this case also, the second storage control device 100(2) is able to store the encryption data received from the first storage control device 100(1) in the normal LU 330B (2) as is without subjecting the data to encryption processing.

That is, when data are transferred from the first storage control device 100(1) which is the transfer source to the second storage control device 100(2) which is the transfer destination and the transfer-target data are encrypted, the data are transferred as is as encryption data. The first storage control device 100(1) does not decrypt the transfer target encryption data. As a result, the confidentiality when data are sent and received between the storage control devices 100(1) and 100(2) can be maintained and repeated encryption can be prevented.

FIG. 22 is a flowchart showing an overview of the data transfer processing between storage control devices of this embodiment. First, the first storage control device 100(1) of the transfer source judges whether data are transferred to the second storage control device 100(2) (S110). For example, it is judged whether an instruction for backup creation or a remote copy or other instruction has been supplied for the LU 330 in the first storage control device 100(1).

When it is determined that data in the first storage control device 100(1) should be transferred to the second storage control device 100(2) (S110:YES), the first storage control device 100(1) judges whether copy source data have been encrypted (S111).

When it is judged that the copy source data have been encrypted (S111:YES), the first storage control device 100(1) transmits the copy source data in an as is state, that is, as encryption data to the second storage control device 100(2) (S112).

When copy source data have not been encrypted (S111:NO), the first storage control device 100(1) judges whether to transmit the copy source data to the second storage control device 100(2) as is as plain data (S113). Whether the copy source data are transmitted from the first storage control device 100(1) to the second storage control device 100(2) as encryption data or as is as plain data depends on the policy established in advance by the user as mentioned in the first embodiment.

When it is determined that the copy source data should be transmitted as encryption data (S113:YES), the first storage control device 100(1) transmits the copy source data to the second storage control device 100(2) after the copy source data have been encrypted in the first storage control device 100(1) (S114).

When it is determined that the copy source data should be transmitted as plain data (S113:NO), the first storage control device 100(1) transmits the copy source data as is to the second storage control device 100(2) (S115).

This embodiment that is constituted in this way also affords the same effects as those of the first embodiment. In addition, in this embodiment, when data are transferred between a plurality of storage control devices 100(1) and 100(2), the encryption of the transfer data can be controlled in accordance with the policy established by the user, futile encryption processing can be prevented and user convenience can be improved.

Further, the present invention is not limited to the above embodiment. A person skilled in the art is able to make a variety of additions and modifications and so forth within the scope of the present invention.

What is claimed is:

1. A storage control device that reads and writes data in accordance with a request from a higher-level device, comprising:
a storage device for storing data received from the higher-level device; and
a controller for controlling the input and output of data to and from the storage device,
wherein the controller comprises:
a configuration management section for managing configuration relating to the encryption of the data received from the higher-level device;
an encryption control section for determining, based on the configuration managed by the configuration management section, whether to encrypt the data received from the higher-level device and store these data in the storage device; and
an encryption processing section that encrypts the data when the encryption control section has determined that the data are to be encrypted.

2. The storage control device according to claim 1, wherein the storage device is constituted as a logical storage device that is provided in a physical storage region of one or a plurality of physical storage drives.

3. The storage control device according to claim 1, wherein the higher-level device comprises an encryption function that encrypts data in the higher-level device before transmitting these data to the controller.

4. The storage control device according to claim 1, wherein a plurality of the higher-level device are provided, the higher-level devices consisting of a mixture of higher-level devices that comprise an encryption function that encrypts data in the higher-level device before transmitting these data to the controller and higher-level devices that do not comprise the encryption function.

5. The storage control device according to claim 1, wherein the encryption control section has a discrimination function that discriminates whether the data received from the higher-level device have been encrypted.

6. The storage control device according to claim 1, wherein the encryption control section comprises a discrimination function that discriminates whether the data has been encrypted by analyzing the data received from the higher-level device and, when the data received from the higher-level device have already been encrypted, the data are stored in the storage device as is and, when the data received from the higher-level device have not been encrypted, the data are stored in the storage device after being encrypted by the encryption processing section.

7. The storage control device according to claim 1, wherein the configuration managed by the configuration management section includes encryption target information.

8. The storage control device according to claim 7, wherein the encryption target is the higher-level device unit.

9. The storage control device according to claim 7, wherein the encryption target is an application program unit that is provided in the higher-level device.

10. The storage control device according to claim 7, wherein the encryption target is an operating system unit that is provided in the higher-level device.

11. The storage control device according to claim 1, wherein the configuration managed by the configuration management section includes information on the encryption target that executes the encryption by the encryption processing section and designation information that designates whether to perform encryption by means of the encryption processing section with respect to the encryption target, and the information on the encryption target and the designation information can be set by the user.

12. The storage control device according to claim 11, wherein the setting section for changing the content of the configuration managed by the configuration management section is connected to the controller.

13. The storage control device according to claim 1, wherein the control section provided in the storage device comprises an encryption circuit for encrypting data that are input, and the encryption processing section encrypts the data received from the higher-level device by using the encryption circuit in the storage device.

14. The storage control device according to claim 1, wherein a mixture of the storage devices that includes storage devices that comprise an encryption circuit for encrypting data that are input and storage devices that do not comprise the encryption circuit are provided;
the controller selects another storage device that comprises the encryption circuit as the write destination when the storage device designated as the write destination of the data received from the higher-level device does not comprise the encryption circuit; and
the encryption processing section encrypts the data received from the higher-level device by using the encryption circuit of the other storage device.

15. The storage control device according to claim 1, wherein a mixture of storage devices that includes storage devices that comprise an encryption circuit for encrypting data that are input and storage devices that do not comprise the encryption circuit are provided;
the controller encrypts the data received from the higher-level device by means of the encryption processing section and stores the data in the designated storage device when the storage device designated as the write destination of the data received from the higher-level device does not comprise the encryption circuit; and
the encryption processing section encrypts the data received from the higher-level device by using the encryption circuit of the designated storage device when the designated storage device comprises the encryption circuit.

16. The storage control device according to claim 1, wherein the controller comprises a file management section for performing file management,
the file management section comprises a file encryption control section that encrypts the data received from the higher-level device in file units; and
the file encryption control section encrypts the data received from the higher-level device in the file units and stores these data in the storage device on the basis of the configuration managed by the configuration management section.

17. The storage control device according to claim 1, wherein the controller is also connected to another storage control device, and in cases where data stored in the storage device are transferred to the other storage control device, the data are transferred to the other storage control device as is without being decrypted when the data stored in the storage device have been encrypted, and the data are transferred to the other storage control device after being encrypted when the data stored in the storage device have not been encrypted.

18. A storage control device connected to a higher-level device and a management terminal, comprising:
a storage device for storing data received from the higher-level device; and
a controller for controlling the input and output of data to and from the storage device,
wherein the controller comprises:
a upper communication section for controlling communication with the higher-level device;
a lower communication section for controlling communication with the storage device;
a management table for managing configuration relating to the encryption of data preset via the management terminal;
an encryption control section for determining whether to encrypt data received via the upper communication section from the higher-level device and for determining whether to decrypt data requested by the higher-level device on the basis of the configuration managed by the management table;
an encryption processing section that encrypts the data when the encryption control section has determined that the data are to be encrypted; and
a decrypting processing section that decrypts the data when the encryption control section has determined that the data are to be decrypted.

19. A method of controlling an encryption function in a storage control device that reads and writes data in accordance with requests from a higher-level device, comprising the steps of:
pre-registering an encryption target that performs data encryption in a management table;
receiving data from the higher-level device;
judging whether the data received from the higher-level device are data relating to the encryption target by using the management table;
determining that the data are to be encrypted when it is judged that the data received from the higher-level device are data that are related to the encryption target;
encrypting the data whose encryption has been determined;
storing the encrypted data in a storage device; and
storing the data in the storage device as is when it is judged that the data received from the higher-level device are data that are unrelated to the encryption target.
